(19) United States
(12) Patent Application Publication
(10) Pub. No.: US 2025/0087951 A1
(43) Pub. Date: Mar. 13, 2025

(54) Connector

(71) Applicant: Tyco Electronics (Shanghai) Co., Ltd., Shanghai (CN)

(72) Inventors: Hua (Andy) Li, Shanghai (CN); Wei Yao, Kunshan (CN)

(73) Assignee: Tyco Electronics (Shanghai) Co., Ltd., Shanghai (CN)

(21) Appl. No.: 18/826,967

(22) Filed: Sep. 6, 2024

(30) Foreign Application Priority Data
Sep. 7, 2023 (CN) 202311156111.7

(51) Int. Cl. H01R 31/06; H01R 13/11

(52) U.S. Cl. CPC H01R 31/06; H01R 13/11

(57) ABSTRACT

A connector includes a housing, a first terminal disposed in the housing, and a second terminal disposed in the housing and located above the first terminal. An adapter terminal is fixed to the first terminal and has a connection end extending beyond the first terminal and the second terminal in a transverse direction of the housing. A first connecting member electrically connects a first conductive component to a top surface of the connection end of the adapter terminal. A second connecting member electrically connects a second conductive component to a top surface of the second terminal.

### CROSS-REFERENCE TO RELATED APPLICATION

This application claims the benefit of the filing date under 35 U.S.C. § 119(a)-(d) of Chinese Patent Application No. 202311156111.7, filed on Sep. 7, 2023.

### FIELD OF THE INVENTION

The present invention relates to a connector, in particular to a power connector.

### BACKGROUND OF THE INVENTION

A power connector typically includes a housing and a first power terminal and a second power terminal arranged in the housing. The first power terminal includes a first elastic arm and a first connecting plate respectively located at both ends. The second power terminal includes a second elastic arm and a second connecting plate respectively located at both ends. The first elastic arm is used for electrical contact with a first mating terminal, and the first connecting plate is electrically connected to a first conductive component through a first connecting component, for example, electrically connected to a first connecting terminal on a first cable end. The second elastic arm is used for electrical contact with a second mating terminal, and the second connecting plate is electrically connected to a second conductive component through a second connecting component, for example, electrically connected to a second connecting terminal on a second cable end.

The second power terminal is located above the first power terminal. The second power terminal and the first power terminal are spaced apart and overlapped with each other in the height direction of the housing, so that the top surface of the first power terminal is covered by the second power terminal. Therefore, the first and second conductive components can only be electrically connected to the bottom surface of the first power terminal and the top surface of the second power terminal, respectively. This results in the first and second connecting components needing to respectively face downwards and upwards, which limits the application range of the connector.

### SUMMARY OF THE INVENTION

A connector includes a housing, a first terminal disposed in the housing, and a second terminal disposed in the housing and located above the first terminal. An adapter terminal is fixed to the first terminal and has a connection end extending beyond the first terminal and the second terminal in a transverse direction of the housing. A first connecting member electrically connects a first conductive component to a top surface of the connection end of the adapter terminal. A second connecting member electrically connects a second conductive component to a top surface of the second terminal.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment when viewed from the front side;

FIG. 2 shows an illustrative perspective view of a connector according to an exemplary embodiment when viewed from the rear side;

FIG. 3 shows an illustrative exploded view of a connector according to an exemplary embodiment;

FIG. 4 shows a longitudinal sectional view of a connector according to an exemplary embodiment;

FIG. 5 shows an illustrative perspective view of the terminals of a connector according to an exemplary embodiment;

FIG. 6 shows an illustrative assembly view of terminals and auxiliary terminals of a connector according to an exemplary embodiment; and

FIG. 7 shows an illustrative exploded view of terminals and auxiliary terminals of a connector according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

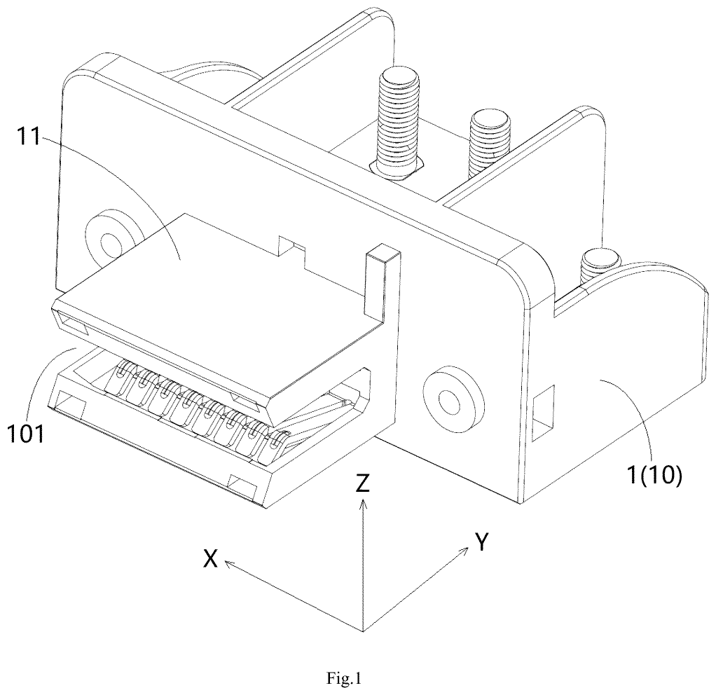

As shown in FIGS. 1 to 5, in an exemplary embodiment of the present invention, a connector is disclosed. The connector includes a housing 1, a first terminal 21, a second terminal 22, an adapter terminal 23, a first connecting member 201, and a second connecting member 202. The first terminal 21 is located in the housing 1. The second terminal 22 is located in the housing 1 and above the first terminal 21. The adapter terminal 23 is fixed to the first terminal 21. The adapter terminal 23 has a connection end 230 that extends beyond the first terminal 21 and the second terminal 22 in the transverse direction X of the housing 1. The first connecting member 201 is used to electrically connect a first conductive component (such as a first connection terminal on a first cable end) to the top surface of the connection end 230 of the adapter terminal 23. The second connecting member 202 is used to electrically connect a second conductive component (such as a second connection terminal on a second cable end) to the top surface of the second terminal 22.

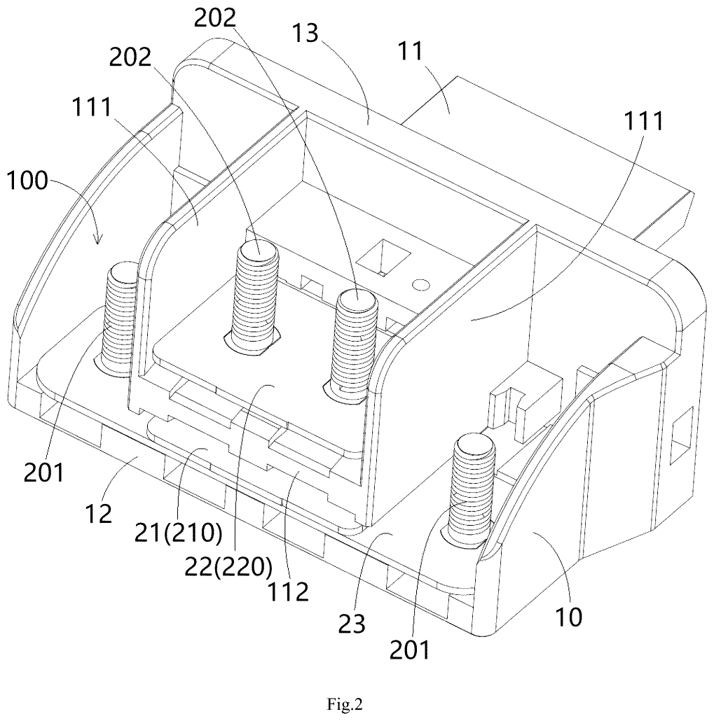

As shown in FIGS. 1 and 2, in the illustrated embodiments, the first terminal 21 and the second terminal 22 are spaced apart and overlap with each other in the height direction Z of the housing 1, so that the top surface of the first terminal 21 is obscured by the second terminal 22 located above it. This results in the first conductive component being unable to be electrically connected to the top surface of the first terminal 21.

In the illustrated embodiments, the first connecting member 201 extends a predetermined length upwards from the top surface of the connection end 230 of the adapter terminal 23 along the height direction Z of the housing 1, and the predetermined length is greater than the distance between the first terminal 21 and the second terminal 22 in the height direction Z of the housing 1, as shown in FIG. 2. This results in the first connecting member 201 being unable to be set between the first terminal 21 and the second terminal 22.

In the illustrated embodiment, the second terminal 22 and the first terminal 21 are the same and symmetrically arranged at the upper and lower sides inside the housing 1.

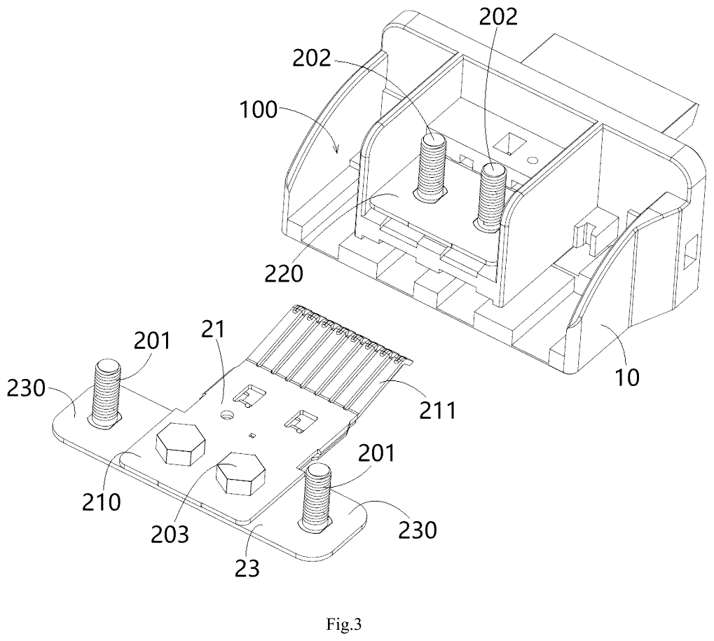

As shown in FIG. 3, in the illustrated embodiments, the first terminal 21 includes a first connection plate portion 210 and multiple first elastic arms 211. The first connection plate portion 210 is perpendicular to the height direction Z of housing 1. Multiple first elastic arms 211 are arranged in a row in the transverse direction X of the housing 1. The adapter terminal 23 is in the shape of a board and is fixed to the bottom or top surface of the first connection plate portion 210.

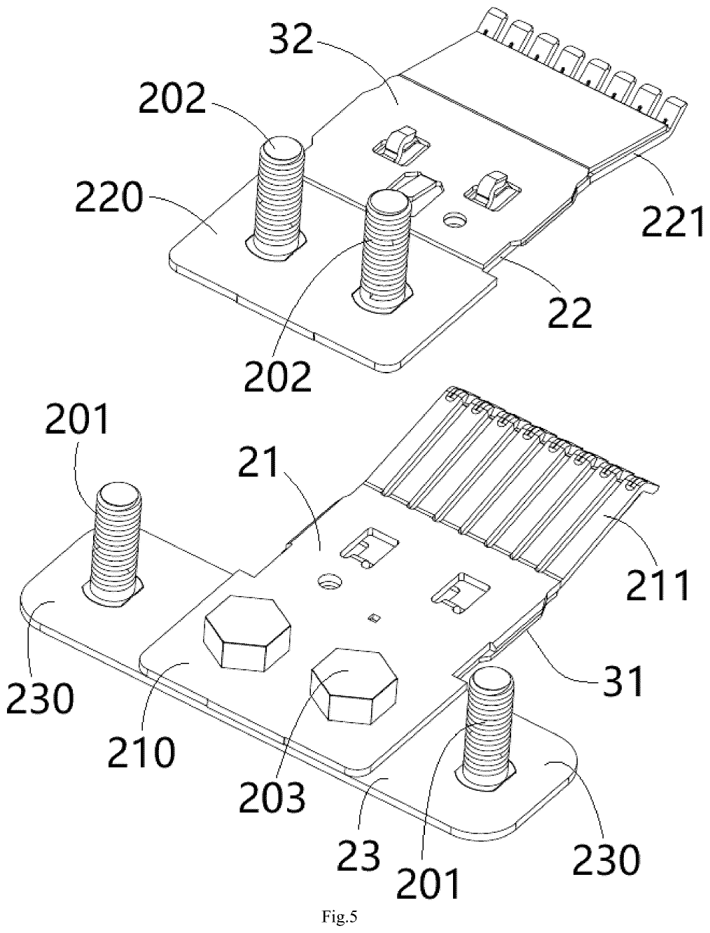

As shown in FIGS. 3 and 5, in the illustrated embodiments, the connector further comprises a third connecting member 203, which is used to connect the adapter terminal 23 to the bottom or top surface of the first connection plate portion 210. However, the present invention is not limited to the illustrated embodiments, for example, the adapter terminal 23 can be welded or riveted to the bottom or top surface of the first connection plate portion 210.

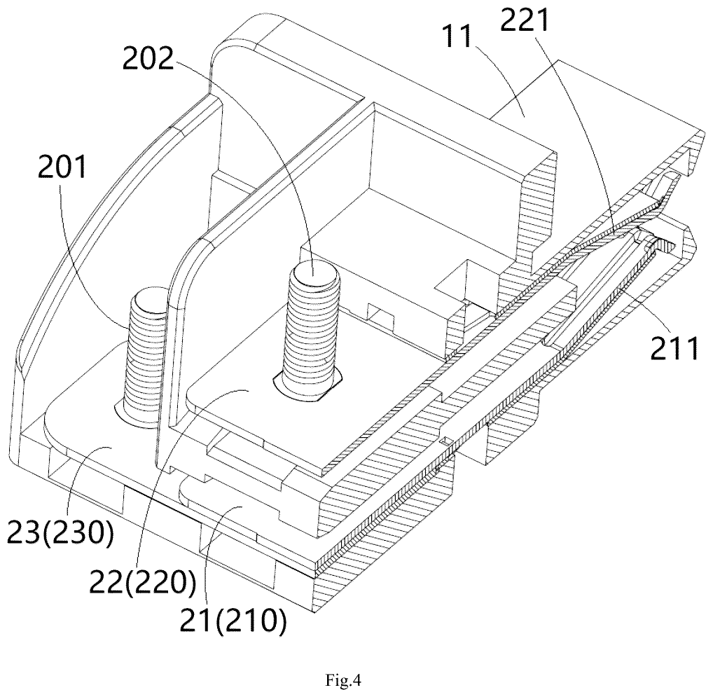

As shown in FIGS. 4 and 5, in the illustrated embodiments, the second terminal 22 includes a second connection plate portion 220 and multiple second elastic arms 221. The second connection plate portion 220 is perpendicular to the height direction Z of the housing 1. Multiple second elastic arms 221 are arranged in a row in the transverse direction X of the housing 1. The second connection plate portion 220 is located above the first connection plate portion 210, and multiple second elastic arms 221 are located above the multiple first elastic arms 211. The second connecting member 202 is used to electrically connect the second conductive component to the top surface of the second connection plate portion 220.

As shown in FIG. 1, in the illustrated embodiments, the housing 1 has front 11 and rear 10 opposite to each other in its longitudinal direction Y, and a slot 101 is formed on the front 11 of the housing 1 that allows for the insertion of a mating plug. The slot 101 extends along the transverse direction X and longitudinal direction Y of the housing 1. The first elastic arm 211 and the second elastic arm 221 are located at the lower and upper sides of the slot 101, respectively, for electrical contact with a first mating terminal and a second mating terminal on the mating plug inserted into the slot 101.

As shown in FIGS. 2 and 3, in the illustrated embodiments, a containment chamber 100 is formed in the rear 10 of the housing 1. The first connection plate portion 210, the second connection plate portion 220, and the adapter terminal 23 are accommodated in the containment chamber 100, and the top and rear sides of the containment chamber 100 are opened to allow the first conductive component and the second conductive component to be placed in the containment chamber 100.

As shown in FIGS. 2 and 3, in the illustrated embodiments, the adapter terminal 23 is fixed to the bottom surface of the first connection plate portion 210 of the first terminal 21 and supported on the inner surface of the bottom wall 12 of the containment chamber 100. The front 11 of housing 1 is tongue shaped and connected to the outer side of the front wall 13 of the rear 10 of housing 1.

As shown in FIG. 2, in the illustrated embodiments, the housing 1 has a pair of vertical partition walls 111 located in the containment chamber 100 and a horizontal partition wall 112 connected between the bottom of the pair of vertical partition walls 111. The horizontal partition 112 is located between the first connection plate portion 210 and the second connection plate portion 220, used to separate the first connection plate portion 210 from the second connection plate portion 220. The pair of vertical partition walls 111 are located at both sides of the transverse direction X of the second connection plate portion 220, respectively, to separate the second connection plate portion 220 from the first connecting member 201.

As shown in FIG. 3, in the illustrated embodiments, the adapter terminal 23 has two connection ends 230 opposite to each other in the transverse direction X of the housing 1, and a first connection hole 21a is formed in each of the two connection ends 230. The connector includes two first connecting members 201, which respectively pass through the first connection holes 21a in the two connection ends 230, and are used to respectively electrically connect the two first conductive components to the top surfaces of the two connection ends 230.

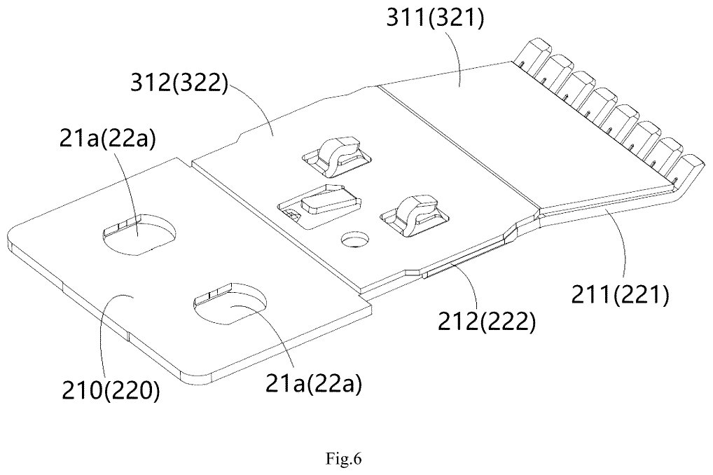

As shown in FIG. 6, in the illustrated embodiments, two second connection holes 22a are formed in the second connection plate portion 220 of the second terminal 22, and the connector includes two second connecting members 202, shown in FIG. 5. The two second connecting members 202 pass through the two second connection holes 22a, respectively, for electrically connecting the two second conductive components to the top surface of the second connection plate portion 220.

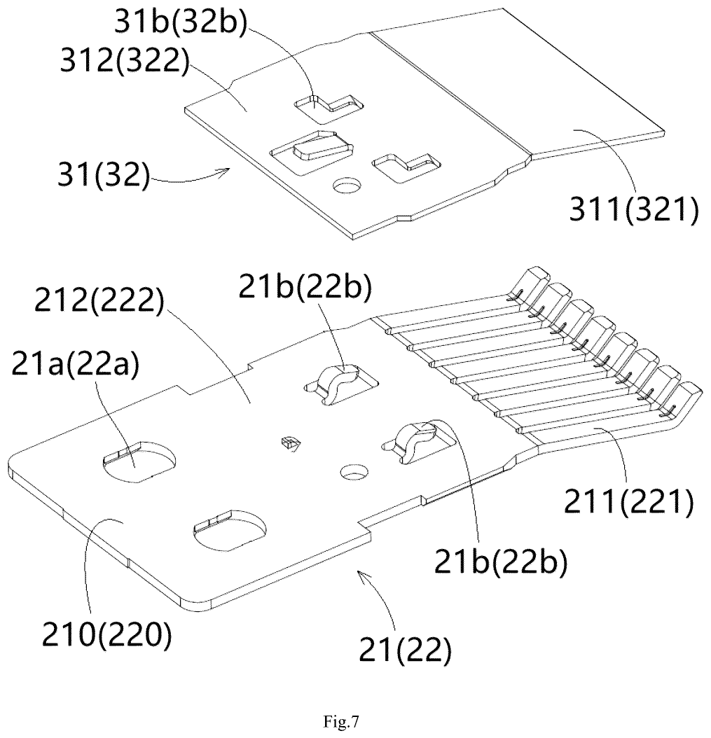

As shown in FIG. 7, in the illustrated embodiment, the first terminal 21 further comprises a first fixation plate portion 212. The first fixation plate portion 212 is connected between the first connection plate portion 210 and the first elastic arm 211 and is fixed in the housing 1. The second terminal 22 also includes a second fixation plate portion 222, which is connected between the second connection plate portion 220 and the second elastic arm 221 and fixed in the housing 1.

As shown in FIGS. 5 and 7, in the illustrated embodiments, the connector further comprises a first auxiliary terminal 31 and a second auxiliary terminal 32. The first auxiliary terminal 31 is installed on the bottom surfaces of the first fixation plate portion 212 and the first elastic arm 211 of the first terminal 21. The second auxiliary terminal 32 is installed on the top surfaces of the second fixation plate portion 222 and the second elastic arm 221 of the second terminal 22.

As shown in FIGS. 6 and 7, in the illustrated embodiment, the first auxiliary terminal 31 comprises a first base plate portion 312 and a first elastic plate 311. The first base plate portion 312 is stacked and fixed on the bottom surface of the first fixation plate portion 212 of the first terminal 21. The first elastic plate 311 is connected to the first base plate portion 312 and pressed against the bottom surface of the first elastic arm 211 to increase the elastic contact force of the first elastic arm 211.

As shown in FIGS. 6 and 7, in the illustrated embodiments, the second auxiliary terminal 32 comprises a second base plate portion 322 and a second elastic plate 321. The second base plate portion 322 is stacked and fixed on the top surface of the second fixed board portion 222 of the second terminal 22. The second elastic plate 321 is connected to the second base plate portion 322 and abuts against the top surface of the second elastic arm 221 to increase the elastic contact force of the second elastic arm 221.

In the illustrated embodiments, the first base plate portion 312 can be buckled, welded, or riveted to the first fixation plate portion 212 of the first terminal 21. The second base plate portion 322 can be buckled, welded, or riveted to the second fixation plate portion 222 of the second terminal 22.

As shown in FIG. 7, in the illustrated embodiments, a first buckle 21b is formed on one of the first base plate portion 312 and the first fixation plate portion 212, and a first snap slot 31b is formed on the other. As shown in FIG. 6, the first buckle 21b is engaged in the first snap slot 31b to fix the first base plate portion 312 to the first fixation plate portion 212. A second buckle 22b is formed on one of the second base plate portion 322 and the second fixation plate portion 222, and a second snap slot 32b is formed on the other. The second buckle 22b is engaged in the second snap slot 32b to fix the second base plate portion 322 to the second fixation plate portion 222.

Each of the first connecting member 201, the second connecting member 202, and the third connecting member 203 may be a screw connection component. For example, it can be a bolt or a screw.

Each of the first terminal 21, the second terminal 22, and the adapter terminal 23 may be an integral stamped part. This can reduce manufacturing costs.

In the illustrated embodiments, the connector is a power connector, and the first terminal 21 and the second terminal 22 are power terminals. However, the present invention is not limited to the illustrated embodiments, and the connector can also be a signal connector for transmitting signals.

In the aforementioned exemplary embodiments of the present invention, the adapter terminal can change the orientation of the first connecting member, so that both the first connecting member for connecting the first terminal and the second connecting member for connecting the second terminal can face the same design orientation, for example, both facing upwards, expanding the application scope of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing;
a first terminal disposed in the housing;
a second terminal disposed in the housing and located above the first terminal;
an adapter terminal fixed to the first terminal and having a connection end extending beyond the first terminal and the second terminal in a transverse direction of the housing;
a first connecting member electrically connecting a first conductive component to a top surface of the connection end of the adapter terminal; and
a second connecting member electrically connecting a second conductive component to a top surface of the second terminal.

2. The connector according to claim 1, wherein the first terminal and the second terminal are separated from and overlapped with each other in a height direction of the housing, a top surface of the first terminal is covered by the second terminal.

3. The connector according to claim 1, wherein the first connecting member extends a predetermined length upwards from the top surface of the connecting end of the adapter terminal along a height direction of the housing, the predetermined length is greater than a distance between the first terminal and the second terminal in the height direction of the housing.

4. The connector according to claim 1, wherein the second terminal and the first terminal are the same and symmetrically arranged at an upper side and a lower side in the housing.

5. The connector according to claim 1, wherein the first terminal includes:
a first connection plate portion that is perpendicular to a height direction of the housing; and
a plurality of first elastic arms arranged in a row in the transverse direction of the housing, the adapter terminal is plate-shaped and fixed to a bottom surface or a top surface of the first connection plate portion.

6. The connector according to claim 5, further comprising a third connecting member connecting the adapter terminal to the bottom surface or the top surface of the first connection plate portion.

7. The connector according to claim 5, wherein the adapter terminal is welded or riveted to the bottom surface or the top surface of the first connection plate portion.

8. The connector according to claim 5, wherein the second terminal includes:
a second connection plate portion perpendicular to the height direction of the housing; and
a plurality of second elastic arms arranged in a row in the transverse direction of the housing, the second connection plate portion is located above the first connection plate portion, the second elastic arms are located above the first elastic arms, the second connecting member electrically connects the second conductive component to a top surface of the second connection plate portion.

9. The connector according to claim 8, wherein the housing has a front and a rear opposite to each other in a longitudinal direction, a slot is formed on the front of the housing that receives a mating plug, the slot extends along the transverse direction and the longitudinal direction of the housing, the first elastic arms and the second elastic arms are respectively located at a lower side and an upper side of the slot, the first elastic arms and the second elastic arms electrical contact a first mating terminal and a second mating terminal on the mating plug inserted into the slot.

10. The connector according to claim 9, wherein a containment chamber is formed in the rear of the housing, the first connection plate portion, the second connection plate portion, and the adapter terminal are accommodated in the containment chamber, a top side and a rear side of the containment chamber are opened to allow the first conductive component and the second conductive component to be placed in the containment chamber.

11. The connector according to claim 10, wherein the adapter terminal is fixed to the bottom surface of the first connection plate portion of the first terminal and supported on an inner surface of a bottom wall of the containment chamber.

12. The connector according to claim 10, wherein the housing has a pair of vertical partition walls located in the containment chamber and a horizontal partition wall connected between a bottom of the pair of vertical partition walls, the horizontal partition wall is between the first connection plate portion and the second connection plate portion and separates the first connection plate portion from the second connection plate portion, the pair of vertical partition walls are respectively located at a pair of lateral sides of the second connection plate portion and separate the second connection plate portion from the first connecting member.

13. The connector according to claim 8, wherein the adapter terminal has a pair of connection ends opposite to each other in the transverse direction of the housing, a first connection hole is formed in each of the connection ends, the first connecting member is one of a pair of first connecting members that respectively pass through the first connection holes in the connection ends and electrically connect a pair of first conductive components to a pair of top surfaces of the connection ends.

14. The connector according to claim 13, wherein a pair of second connection holes are formed in the second connection plate portion of the second terminal, the second connecting member is one of a pair of second connecting members that respectively pass through the second connection holes and electrically connect a pair of second conductive components to the top surface of the second connection plate portion.

15. The connector according to claim 8, wherein the first terminal includes a first fixation plate portion connected between the first connection plate portion and the first elastic arms, the first fixation plate portion is fixed in the housing, the second terminal includes a second fixation plate portion connected between the second connection plate portion and the second elastic arms, the second fixation plate portion is fixed in the housing.

16. The connector according to claim 15, further comprising:
a first auxiliary terminal installed on a bottom surface of the first fixation plate portion and on a plurality of bottom surfaces of the first elastic arms of the first terminal; and
a second auxiliary terminal installed on a top surface of the second fixation plate portion and on a plurality of top surfaces of the second elastic arms of the second terminal.

17. The connector according to claim 16, wherein the first auxiliary terminal includes:
a first base plate portion stacked and fixed on the bottom surface of the first fixation plate portion of the first terminal; and
a first elastic plate connected to the first base plate portion and resting against the bottom surfaces of the first elastic arms.

18. The connector according to claim 17, wherein the second auxiliary terminal includes:
a second base plate portion stacked and fixed on the top surface of the second fixation plate portion of the second terminal; and
a second elastic plate connected to the second base plate portion and resting against the top surfaces of the second elastic arms.

19. The connector according to claim 18, wherein a first buckle is formed on one of the first base plate portion and the first fixation plate portion, and a first snap slot is formed on the other, the first buckle is engaged in the first snap slot to fix the first base plate portion to the first fixation plate portion, a second buckle is formed on one of the second base plate portion and the second fixation plate portion, and a second snap slot is formed on the other, the second buckle is engaged in the second snap slot to fix the second base plate portion to the second fixation plate portion.

20. The connector according to claim 1, wherein the connector is a power connector, and the first terminal and the second terminal are power terminals.
